(19) United States
(12) Patent Application Publication
(10) Pub. No.: US 2007/0264475 A1
(43) Pub. Date: Nov. 15, 2007

(54) TWO-DIMENSIONAL SIZE-REDUCTION OF SURFACE FEATURES BY REPLICA-CASTING

(75) Inventor: Dennis R. Strauss, Ventura, CA (US)

Correspondence Address: THE BOEING COMPANY;c/o FELIX L. FISCHER, ATTORNEY AT LAW, 1607 MISSION DRIVE, SUITE 204, SOLVANG, CA, 93463, US

(73) Assignee: The Boeing Company, Chicago, IL (US)

(21) Appl. No.: 11/382,385

(22) Filed: May 9, 2006

(51) Int. Cl. B44C 1/17

(52) U.S. Cl. 428/195.1

(57) ABSTRACT

Size reduction of surface features is accomplished by stretching an elastomeric sheet isotropically, coating it with a curable elastomer precursor, impressing a surface pattern into the precursor coating with a mold, curing the precursor coating to form a patterned elastomeric coating on the substrate elastomeric sheet, removing the pattern mold, and then allowing the substrate elastomeric sheet to relax to its original size. The cured patterned coating is forced to contract isotropically by the relaxing elastomeric sheet, creating a new surface pattern whose features will be reduced in size, while retaining the relief of the features.

### BACKGROUND OF THE INVENTION

1. Field of the Invention

This invention relates generally to the field of micron-scale three dimensional (3D) surface feature manufacturing and more particularly to a method and apparatus for obtaining reduced size features by casting on an elastic membrane.

2. Description of the Related Art

Arbitrary millimeter-scale 3D surface features can be produced by direct-write additive or subtractive automated manufacturing processes. Presently, direct-write additive or subtractive mechanical methods fail at producing micron-scale 3D surface features because microscale mechanical tools have insufficient stiffness or strength to machine at the required resolution, and surface tension limits the resolution of liquid-phase additive techniques. Indirect methods, such as grayscale photolithography, and direct optical methods, such as UV laser ablation, and two-photon polymerization can produce submicron 3D surface features at substantially increased cost. Diffraction limits the resolution of the optical methods, and introducing shorter wavelengths to the optical methods increases costs again.

It is therefore desirable to introduce a low-cost technique which can extend each of these patterning methods to finer scales.

It is further desirable to provide a micron scale manufacturing technique which reduces the size of the features biaxially while maintaining the desired relief of the manufactured features.

### SUMMARY OF THE INVENTION

A system and method incorporating the present invention provides for stretching an elastomeric sheet isotropically, coating it with a curable elastomer precursor, impressing a surface pattern into the precursor coating with a mold, curing the precursor coating to form a patterned elastomeric coating on the substrate elastomeric sheet, removing the pattern mold, and then allowing the substrate elastomeric sheet to relax to its original size. The cured patterned coating is forced to contract isotropically by the relaxing elastomeric sheet, creating a new surface pattern whose features will be reduced in size, while retaining the relief of the features.

In a first embodiment, stretching of the elastomeric sheet is accomplished with a stretcher having a frame with attachment manipulators extending radially inward and attaching to the membrane with clamps. Retracting the manipulators stretches the membrane to receive the elastomeric coating. An alternative embodiment employs a biaxial stretcher to engage and stretch the elastomeric sheet biaxially.

### BRIEF DESCRIPTION OF THE DRAWINGS

The features and advantages of the present invention will be better understood by reference to the following detailed description when considered in connection with the accompanying drawings wherein:

FIG. 1 is a first embodiment of the isotropic stretching frame and manipulators engaging an elastomeric membrane according to the present inventive method;

FIG. 2 is flow chart of the steps of the inventive method;

FIG. 3 is a flow chart of the extended method of the present invention; and,

FIG. 4 is an exemplary flow schematic of the method steps and apparatus of the invention.

### DETAILED DESCRIPTION OF THE INVENTION

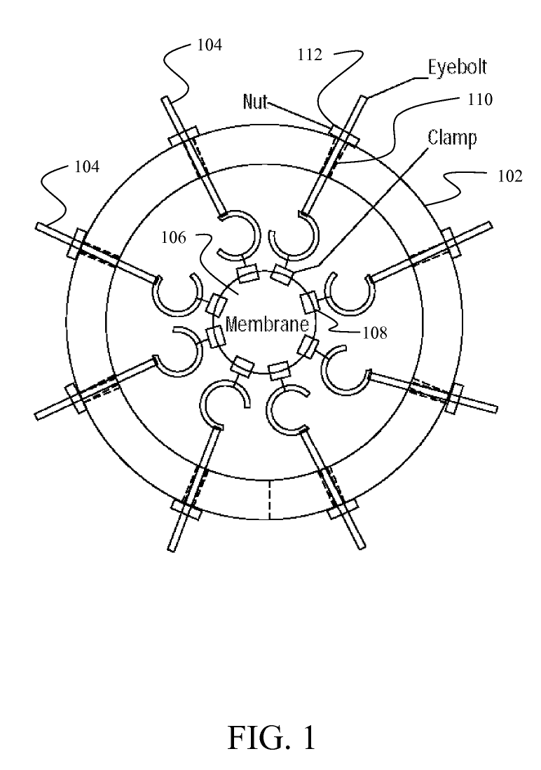

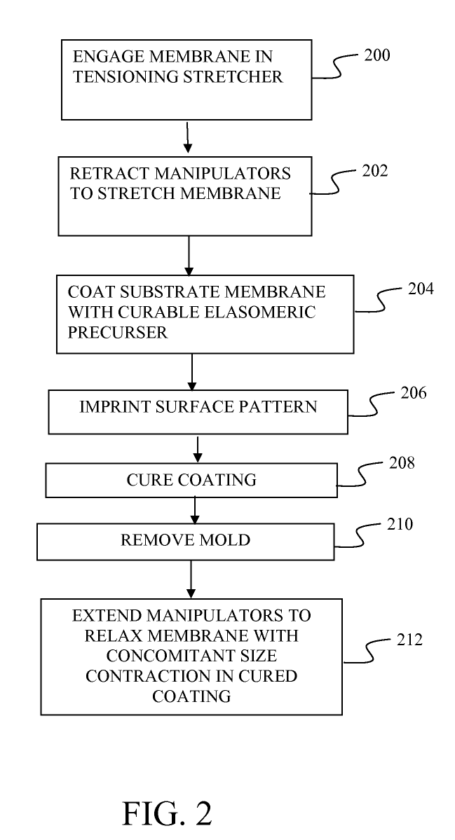

The present invention provides a method and apparatus for micron-scale feature manufacturing. As shown in FIG. 1, a stretching frame 102 having attachment manipulators 104 engages an elastomeric membrane 106 using clamps 108. The clamps secure the manipulators around the periphery of the membrane to allow stretching the membrane isotropically. The attachment manipulators shown in the drawings incorporate screw threads 110 received in adjustment nuts 112. FIG. 2 provides a flow chart of the method of the present invention. The membrane is engaged 200 by the tensioning system. By tensioning the adjustment nuts for the embodiment shown in FIG. 1, the attachment manipulators retract 202 stretching the elastomeric membrane radially to provide a first sizing of the membrane as a substrate.

The membrane substrate is then coated 204 with a curable elastomer precursor on each side using an applicator brush, or by pumping the precursor out of a syringe. Double sided coating is employed such that the cured patterned substrate will relax symmetrically after the molds are removed and the tension is released as described below. A surface pattern is imprinted 206 into the precursor coating with a mold. In exemplary embodiments, molds are applied to each side of the stretched and coated substrate and clamped into place. Excess precursor which squeezes out from under the molds is wiped away. The substrate is then cured 208.

Multiple curing approaches are available for use in the present invention. In certain embodiments, the molds are transparent and a UV-curing precursor is used, the coating is then cured in a UV curing chamber. Alternatively a room temperature curing precursor is used and no exposure to UV or heat is required. A heat-curing precursor is used for other embodiments with heated platens attached to the molds, or radiation from heat lamps directed at the outer surface of the molds, or the whole assembly placed in a convection oven. Typical heating ramp rates are from 1 to 5° C./minute. Typical heating times at temperature range from 4 hours at 65° C. to 1 hour at 100° C.

The precursor coating, when cured, forms a patterned elastomeric coating on the substrate elastomeric membrane. The pattern molds are then removed 210 from each side of the stretched substrate. The attachment manipulators are extended 212 by de-tensioning the adjustment nuts and the substrate elastomeric membrane is allowed to relax to approximately its original size. The cured patterned coating contracts with the membrane creating a new surface pattern with features reduced in size. The relief of the features in the cured pattern is maintained or increased based on volume expansion in the unconstrained dimension during relaxation of the membrane.

In exemplary embodiments, the elastomeric membrane is Silicone ⅛″ to ¼″ thick with a Shore A hardness of 40-50 and elongation greater than 100% and preferably greater than 300%. In alternative embodiments, a Polyurethane membrane is employed.

An exemplary silicone precursor for the pattern coating is Dragon Skin Q produced by Smooth-On, Inc. The Properties of this precursor are shown in Table 1.

TABLE 1

| Shore A hardness: | 10 | |
|---|---|---|
| Mix Ratio: | 1:1 | pbw, pbv |
| Color: | Translucent | |
| Pot Life: | 8 | Min. |
| Demold Time: | 75 | Min. |
| Specific Volume: | 25.8 | |
| Specific Gravity: | 1.07 | |
| Mixed Viscosity: | 23,000 | cps |
| Die B Tear Strength: | 102 | pli |
| Tensile Strength: | 475 | psi |

| | |
|---|---|
| Shrinkage: | Negligible |

The alternative polyurethane membrane requires a silicone primer, such as Nusil SP-270, to enhance adherence of the silicone coating to the membrane.

The embodiment shown in FIG. 1 provides a radial stretching of the membrane for use in radially symmetric patterns. A biaxial stretcher is employed in alternative embodiments for orthogonally symmetric patterns. Commercially available biaxial film stretchers such as the Accu-Pull™ produced by Inventure Laboratories Inc. P.O. Box 30457, Knoxville, Tenn. 37930-0457 provide desired process control capability.

Exemplary patterns on which the present inventive combination is employed include pyramids, prisms, grooves, lenses and arbitrary relief patterns with pitch of 0.01 micron to 100 microns and relief of 0.01 micron to 50 microns. Exemplary starting substrate sizes are 1″ to 6″ diameter. A typical mold is about 0.5″ less in diameter than the stretched substrate to allow space for the tensioning clamps. The substrate is typically stretched from 20% to 100% in diameter. A typical mold pattern would have 50 micron features 20 microns in height. Materials for the pattern mold used for imprinting the precursor surface pattern are metals such as electroformed nickel, machined aluminum, electrochemically-etched aluminum or titanium or silicon, hard polymers such as epoxy, acrylic, polyurethane, polypropylene, nylon or ceramics such as fused silica and glass.

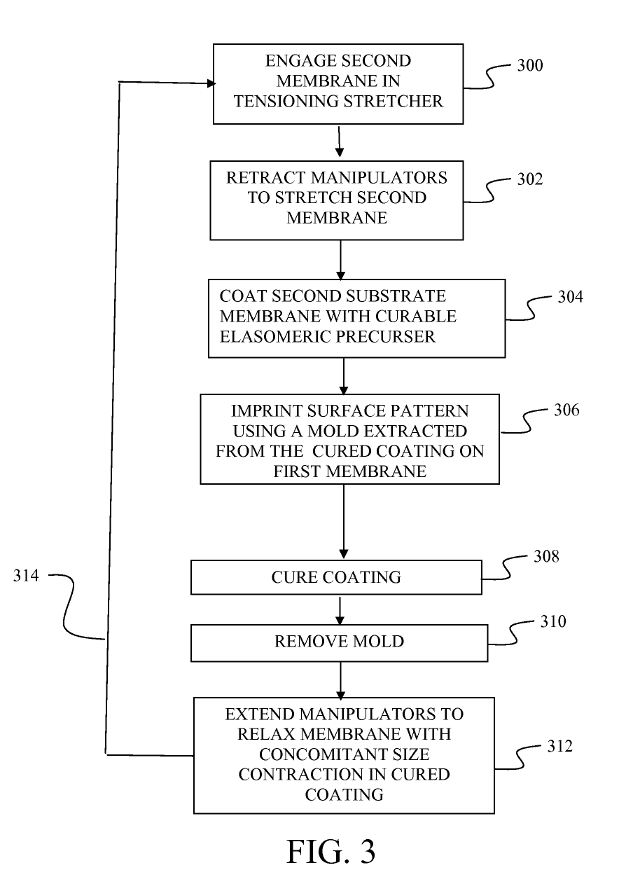

In an extended embodiment of the method of the present invention shown in FIG. 3, the cured elastomeric pattern is employed as a reduced scale negative of the initial mold for casting a new mold in a hard material such as epoxy. The new reduced-scale mold is used for imprinting 306 an elastomeric precursor on a second membrane which has been engaged on a tensioning stretcher 200, stretched 302 and coated with an elastomeric precursor 204. The second membrane is then cured 308. The reduced-scale mold is then removed 310 and the second membrane is relaxed 312 contracting the second cured elastomeric coating for further size reduction in the features. This extended process is repeated 314 in certain embodiments for continued size reduction and/or feature reversal from the negative mold. Alternatively, the first reduced negative pattern is reversed to make a new reduced-size positive mold before the next size-reduction cycle is started. The mold is be made out of a hard material so that it doesn't deform as it is pressed against the coated stretched substrate and material selection for the mold is made to preclude adherence of the mold to the substrate.

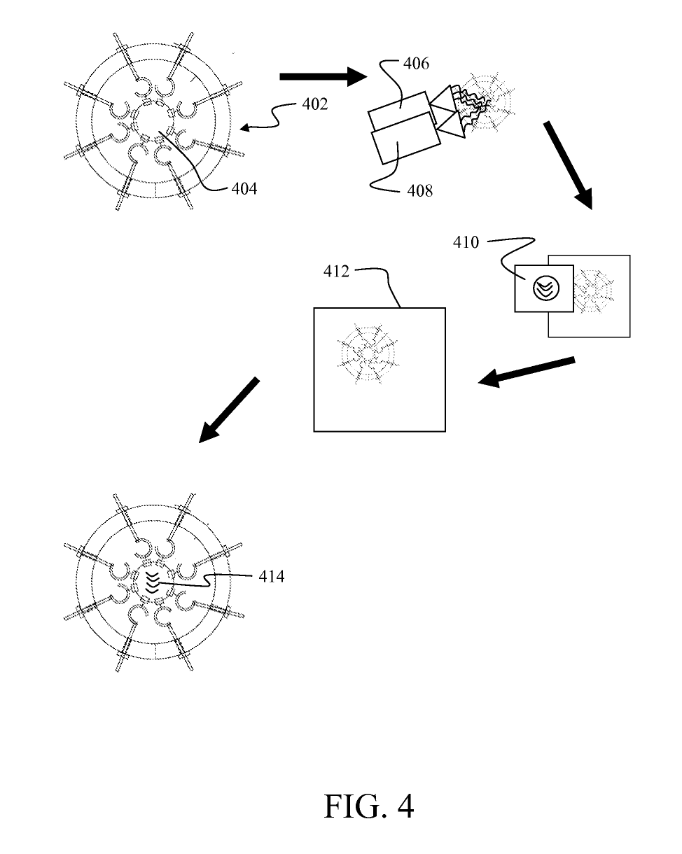

The production system for the replica casting product of the present invention is shown in FIG. 4. The stretcher 402 engages and stretches the elastomeric membrane 404. The elastomeric coating is applied to the stretched membrane by a coater 406 which for certain applications includes a primer coater 408. The coating is then imprinted using a mold 410 and then cured in a curing system 412. The stretcher is removed from the curing system and the membrane is relaxed to provide the reduced scale replica casting 414.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A method for size reduction of surface features comprising the steps of:
providing an elastomeric membrane;
stretching the elastomeric membrane;
coating the stretched elastomeric membrane with an elastomeric coating;
imprinting a pattern in said elastomeric coating using a mold;
curing the patterned elastomeric coating;
removing the mold; and
relaxing the membrane with concomitant contraction of the elastomeric coating.

2. A method as defined in claim 1 wherein the elastomeric membrane is Silicone.

3. A method as defined in claim 2 wherein the Silicone membrane has a thickness of about ⅛″ to ¼″.

4. A method as defined in claim 2 wherein the Silicone membrane has a Shore hardness of about 40-50.

5. A method as defined in claim 1 wherein after the step of stretching the elastomeric membrane has an elongation of at least 100%.

6. A method as defined in claim 1 wherein after the step of stretching the elastomeric membrane has an elongation of about 300%.

7. A method as defined in claim 1 wherein the elastomeric coating is a silicone precursor.

8. A method as defined in claim 1 wherein the elastomeric membrane is polyurethane.

9. A method as defined in claim 8 wherein the elastomeric coating is a silicone precursor and the step of coating the stretched elastomeric membrane includes a preliminary step of priming the membrane with a silicone primer.

10. A method as defined in claim 1 wherein the elastomeric membrane is stretched isotropically.

11. A method as defined in claim 1 wherein the elastomeric membrane is stretched radially

12. A method as defined in claim 1 wherein the elastomeric membrane is stretched biaxially.

13. A method as defined in claim 1 further comprising the steps of:
providing a second elastomeric membrane;
stretching the second elastomeric membrane;
coating the stretched second elastomeric membrane with a second elastomeric coating;
imprinting a pattern in said second elastomeric coating using a second mold formed from the first membrane with the contracted elastomeric coating;
curing the patterned second elastomeric coating;
removing the second mold; and
relaxing the second membrane with concomitant contraction of the second elastomeric coating.

14. A system for replica-casting with two dimensional size reduction of features comprising:
an elastomeric substrate;
a stretcher engaging the elastomeric substrate and adapted for placing the substrate in a first stretched condition and a second relaxed condition;
means for coating the elastomeric substrate in the first stretched condition with an elastomeric coating; and,
means for imprinting a surface pattern in the elastomeric coating, wherein the elastomeric coating contracts with the elastomeric substrate in the second relaxed condition.

15. A system as defined in claim 14 further comprising means for curing the elastomeric coating.

16. A system as defined in claim 14 wherein the stretcher comprises a frame having a plurality of manipulators extending inwardly therefrom to engage the elastomeric substrate substantially around a periphery thereof, the manipulators retractable from a first position with the elastomeric substrate in the relaxed condition to a second position with the elastomeric substrate in the stretched condition, the manipulators further extendible from the second position to the first position.

17. A system as defined in claim 16 wherein the stretcher comprises a biaxial stretcher.

18. A system as defined in claim 16 wherein the stretcher comprises a radial stretcher.

19. A system as defined in claim 14 further comprising means for curing the elastomeric coating.

20. A system as defined in claim 14 wherein the elastomeric membrane is Silicone.

21. A method as defined in claim 20 wherein the Silicone membrane has a thickness of about ⅛″ to ¼″.

22. A system as defined in claim 20 wherein the Silicone membrane has a Shore hardness of about 40-50.

23. A system as defined in claim 20 wherein the elastomeric membrane has an elongation of at least 100%.

24. A system as defined in claim 20 wherein the elastomeric membrane has an elongation of about 300%.

25. A system as defined in claim 14 wherein the elastomeric coating is a silicone precursor.

26. A system as defined in claim 14 wherein the elastomeric membrane is polyurethane.

27. A system as defined in claim 26 wherein the elastomeric coating is a silicone precursor and the system includes means for applying a silicone primer intermediate the elastomeric coating and the elastomeric substrate.

28. A replica casting having reduced size features comprising:
an elastomeric membrane having an elastomeric coating applied to the elastomeric membrane in a stretched condition, the coating having an imprinted pattern reduced in size by relaxing of the membrane from the stretched condition with concomitant contraction of the elastomeric coating.

29. A replica casting as defined in 28 wherein the elastomeric membrane is silicone.

30. A replica casting as defined in claim 29 wherein the Silicone membrane has a thickness of about ⅛″ to ¼″.

31. A replica casting as defined in claim 29 wherein the Silicone membrane has a Shore hardness of about 40-50.

32. A replica casting as defined in claim 28 wherein after the elastomeric membrane has an elongation of at least 100% in the stretched condition.

33. A replica casting as defined in claim 28 wherein the elastomeric membrane has an elongation of about 300% in the stretched condition.

34. A replica casting as defined in claim 28 wherein the elastomeric coating is a silicone precursor.

35. A replica casting as defined in claim 28 wherein the elastomeric membrane is polyurethane.

36. A replica casting as defined in claim 28 wherein the elastomeric coating is a silicone precursor and the stretched elastomeric membrane includes a preliminary step of priming the membrane treated with a silicone primer.

37. A replica casting as defined in claim 28 wherein the elastomeric membrane is stretched isotropically.
